(19) United States
(12) Patent Application Publication
(10) Pub. No.: US 2009/0175149 A1
(43) Pub. Date: Jul. 9, 2009

(54) HOLOGRAPHIC INFORMATION RECORDING AND/OR REPRODUCING APPARATUS

(75) Inventors: Jae-cheol Bae, Suwon-si (KR); Taek-seong Jeong, Suwon-si (KR); Tae-kyung Kim, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/211,934

(22) Filed: Sep. 17, 2008

(30) Foreign Application Priority Data
Jan. 9, 2008 (KR) 2008-2649

(51) Int. Cl. G11B 7/00

(52) U.S. Cl. 369/103

(57) ABSTRACT

A holographic information recording and/or reproducing apparatus includes a light pickup optical system and a recording power control unit. The light pickup optical system illuminates reference light and signal light onto an information storing medium. The recording power control unit controls the light pickup optical system such that recording power of the reference light is the same as that of signal light.

### CROSS-REFERENCE TO RELATED APPLICATION

This application claims the benefit of Korean Patent Application No. 2008-2649, filed on Jan. 9, 2008 in the Korean Intellectual Property Office, the disclosure of which is incorporated herein in its entirety by reference.

### BACKGROUND OF THE INVENTION

1. Field of the Invention

Aspects of the present invention relate to a holographic information recording and/or reproducing apparatus, and more particularly, to a holographic information recording and/or reproducing apparatus that can control condensing efficiencies of a signal light and a reference light.

2. Description of the Related Art

Recently, information storing technology using a hologram is in the limelight. An information storing method using the hologram stores information in the form of an optical interference pattern in an inorganic crystal, or a photo polymer material that is sensitive to light, of an information storing medium. The optical interference pattern is formed using two laser beams that exhibit interference. That is, the optical interference pattern is formed when a reference light and a signal light, via different paths respectively, interfere with each other to cause a chemical or physical change on a photosensitive information storing medium to thereby record information. To reproduce the information from the interference pattern recorded in this way, a reference light similar to the one that was used when the information was recorded is illuminated onto the interference pattern recorded in the information storing medium. When the reference light is illuminated on to the information storing medium, diffraction caused by the interference pattern is generated to recover the signal light, and to reproduce the information.

Such hologram information storing technology includes a volume holography method for recording/reproducing information by units of pages using a volume holography, and a micro holography method for recording/reproducing information by units of bits using micro holography. The volume holography method is able to process large scale information simultaneously, but an optical system for this method should be controlled very precisely. Therefore, the volume holography method is too difficult to be commercialized to an information storing apparatus for general consumer use.

Meanwhile, the micro holography method allows two condensed beams to interfere with each other at a focal point to form a fine interference pattern, and moves focal lengths of the two condensed beams on a plane of the information storing medium to form a plurality of interference patterns, thereby recording information on an information plane. Further, the micro holography method is usable with a plurality of information planes in the depth direction of the storing medium to three-dimensionally record information in the information storing medium. To record information over the plurality of information planes, a signal light optical system should move a focus point at which a signal light is condensed in the depth direction, and simultaneously, a reference light optical system should move a focus point at which a reference light is condensed to a same position as that of the focus point of the signal light. However, according to a typical micro holograph recording and/or reproducing apparatus, condensing efficiencies of the signal light and the reference light change as the respective focus points of the signal light and the reference light are varied. The change in the condensing efficiencies reduces diffraction efficiency during a recording operation, deteriorates reproduction signals, and makes reproduction signals vulnerable to noise during a reproducing operation of the recording and/or reproducing apparatus.

### SUMMARY OF THE INVENTION

Aspects of the present invention provide a holographic information recording and/or reproducing apparatus that can make a recording strength of a signal light equal to that of a reference light.

According to an aspect of the present invention, a holographic information recording and/or reproducing apparatus includes: a light pickup optical system to illuminate reference light and signal light onto a holographic information storing medium; and a recording power control unit to control the light pickup optical system such that recording power of the reference light is the same as that of signal light.

According to an aspect of the present invention, the light pickup optical system may include a light source unit to emit the reference light and the signal light; a recording power detecting unit to detect light powers of the reference light and the signal light; a light path guide unit to guide the reference light and the signal light emitted from the light source unit to different light paths, respectively; and an objective lens optical system to illuminate the reference light and the signal light guided by the light path guide unit onto a holographic information storing medium.

According to an aspect of the present invention, the light source unit may include: a light source; and a light dividing unit to divide an incident light from the light source unit into the reference light and the signal light, the light dividing unit controlling a ratio of the reference light to the signal light.

According to an aspect of the present invention, the light dividing unit may include a polarization conversion device to control a ratio of polarization components of incident light that are perpendicular to each other; and a polarization beam splitter to divide the incident light that has passed through the polarization conversion device according to the polarization components of the incident light.

According to an aspect of the present invention, the polarization conversion device may include: a rotatable half-wave plate to rotate around an optical axis to change an angle between the optical axis and a polarization direction of the incident light; and a driving unit to drive the rotatable half-wave plate, the driving unit being controlled by the recording power control unit.

According to an aspect of the present invention, the polarization conversion device may polarization-converts the incident light such that the incident light has linear polarization components perpendicular to each other, and polarization-converts the incident light such that the incident light has only a polarization component of the reference light during a reproducing mode.

According to an aspect of the present invention, the light pickup optical system may further include a focus control unit to control positions of foci of the reference light and the signal light formed in the holographic information storing medium in a depth direction to form a plurality of information planes formed of interference patterns between the reference light and the signal light.

According to an aspect of the present invention, the recording power detecting unit may include: a first beam splitter and a second beam splitter located respectively on light paths of the reference light and the signal light guided by the light path guide unit to paths different from each other, respectively; and a reference light detector and a signal light detector to detect the reference light and the signal light divided by the first and second beam splitters, respectively.

According to an aspect of the present invention, the recording power detecting unit may include a first polarization device and a second polarization device disposed between a polarization beam splitter and a first beam splitter, and between the polarization beam splitter and a second beam splitter to change a portion of a polarization component of the incident light into a polarization component that is perpendicular to the portion of the polarization component, and the first and second beam splitters may be polarization beam splitters.

According to an aspect of the present invention, the light path guide unit may guide the reference light and the signal light emitted from the light source unit such that they are illuminated to face each other on both sides of the holographic information storing medium.

According to an aspect of the present invention, the light path guide unit may guide the reference light and the signal light emitted from the light source unit such that they are illuminated on one side of the holographic information storing medium.

According to an aspect of the present invention, the recording power control unit may include: a recording power comparing operator to perform an operation on recording powers of the reference light and the signal light to compare the recording powers using light powers of the reference light and the signal light detected by the light pickup optical system; and a recording power controller to control the light pickup optical system such that recording powers of the reference light and the signal light operated by the recording power comparing operator are the same.

According to an aspect of the present invention, the recording power comparing operator may perform an operation on the recording powers of the reference light and the signal light with consideration of change in a number of apertures, and change in aperture sizes of the reference light and signal light depending on a recording position.

According to an aspect of the present invention, a holographic information recording and/or reproducing apparatus includes: a light pickup optical system to provide a reference light and a signal light to a holographic information storing medium, the reference light and the signal light generating interference patterns representing data for recording in the holographic information storing medium; a recording power detecting unit to detect recording powers of the reference light and the signal light that vary based on change in locations of foci formed by the reference light and the signal light in a depth direction of the holographic information storing medium; and a recording power control unit to control the light pickup optical system to adjust the respective recording powers of the reference light and the signal light based on a determination that a difference of the recording powers of the reference light and the signal light is within a designated tolerance so the respective recording powers are considered to be the same.

According to an aspect of the present invention, a method of recording data on a holographic information storing medium using a holographic information recording and/or reproducing apparatus, includes: providing a reference light and a signal light to the holographic information storing medium, the reference light and the signal light generating interference patterns representing data for recording in the holographic information storing medium; detecting recording powers of the reference light and the signal light that vary based on change in locations of foci formed by the reference light and the signal light in a depth direction of the holographic information storing medium; and adjusting the respective recording powers of the reference light and the signal light based on a determination that a difference of the recording powers of the reference light and the signal light is within a designated tolerance so the respective recording powers are considered to be the same.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 is a schematic view of a holographic information recording and/or reproducing apparatus according to an aspect of the present invention;

FIG. 2 is a reference view explaining a change in recording power according to a change in a recording position in the holographic information recording and/or reproducing apparatus of FIG. 1;

FIG. 3 is a graph illustrating a change in the diffraction efficiency of a reference light or a signal light according to a change in a recording position;

FIG. 4 is a schematic view of a holographic information recording and/or reproducing apparatus according to another aspect of the present invention;

FIG. 5 is a view illustrating a reference light, a signal light, and a servo light illuminated onto a holographic information storing medium; and

FIG. 6 is a flowchart explaining a method of controlling recording powers of a reference light and a signal light during holographic information recording/reproduction operations according to an aspect of the present invention.

### DETAILED DESCRIPTION OF THE EMBODIMENTS

Reference will now be made in detail to aspects of the present invention, examples of which are illustrated in the accompanying drawings, wherein like reference numerals refer to the like elements throughout. The aspects are described below in order to explain the present invention by referring to the figures.

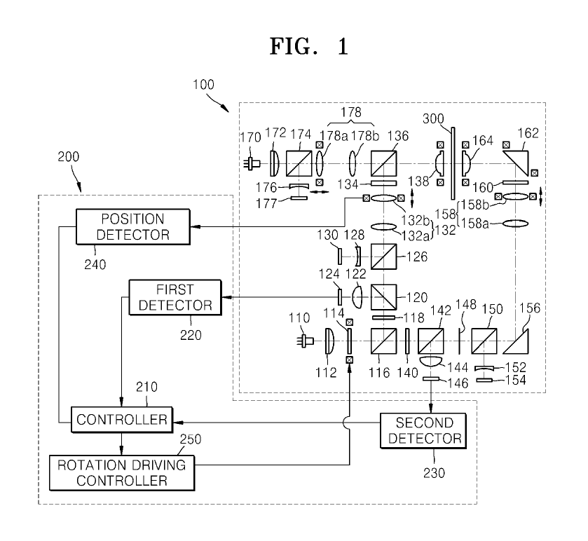

FIG. 1 is a schematic view of a holographic information recording and/or reproducing apparatus according to an aspect of the present invention. Referring to FIG. 1, the holographic information recording and/or reproducing apparatus is an apparatus to record and/or reproduce information to/from a holographic information storing medium 300, and includes a light pickup optical system 100 to illuminate light on both sides of the holographic information storing medium 300 and to receive the illuminated light, and a circuit unit 200.

The light pickup optical system 100 can include a first light source 110, a polarization conversion device 114, a first polarization beam splitter 116, a first polarizing device 118, a reference beam splitter 120, a reference light detector 124, a first focus control unit 132, a wavelength selective beam splitter 136, a first quarter-wave plate 134, a first objective lens 138, a second polarizing device 140, a signal beam splitter 142, a signal light detector 146, a shutter 148, a second focus control unit 158, a second quarter-wave plate 160, and a second objective lens 164. Also, the light pickup optical system 100 can further include a second polarization beam splitter 126 to detect recording/reproducing light reflected by or transmitted from the holographic information storing medium 300 during recording/reproducing operations, a first light detector 130, a third polarization beam splitter 150, and a second light detector 154.

Also, the light pickup optical system 100 can further include a second light source 170, a servo light polarization beam splitter 174, a servo light focus control unit 178, and a servo light detector 177 in order to read servo information. Reference numerals 112 and 172 refer to collimating lenses to collimate light into parallel light. Reference numerals 122, 128, 144, 152, and 176 refer to lenses for making light detection easier. Reference numerals 156 and 162 refer to mirrors that change a light path.

With reference to FIG. 1, the first light source 110 emits light that is linearly polarized in one direction for recording/reproducing operations. The first light source 110 can be a semiconductor laser diode that emits blue light. The light for the recording/reproducing operations emitted from the first light source 110 is modulated and emitted during a recording mode, and is emitted without modulation during a reproducing mode.

The polarization conversion device 114, for example, includes a rotatable half-wave plate that can control a ratio of polarization components of an incident light that are perpendicular to each other, and a mechanical driving unit to drive the rotatable half-wave plate. The rotatable half-wave plate is installed to rotate around an optical axis of the rotatable half-wave plate to change an angle between the optical axis and the polarization direction of the incident light.

The mechanical driving unit drives the rotatable half-wave plate in response to a control of the circuit unit 200. For example, during a recoding mode, an angle between the optical axis, i.e., the fast axis of the rotatable half-wave plate, and the polarization direction of incident light is set to a value excluding 45 degrees, for example, 22.5 degrees. During a reproducing mode, the fast axis of the rotatable half-wave plate is set to be the same as the polarization direction of the incident light. Therefore, during the recording mode, light emitted from the first light source 110 is polarized to have p-polarization and s-polarization components, for example, and during the reproducing mode, light emitted from the first light source 110 is set to maintain its original polarization. Accordingly, the p-polarization component and s-polarization component of the light that is polarized during the recording mode correspond to the reference light and the signal light, respectively, and the transmitted light in the reproducing mode, i.e., p-polarized light, corresponds to a reproducing light. Descriptions of specific polarization directions will be made with the assumption that the reference light and the reproducing light are p-polarized for convenience of description.

Meanwhile, the polarization conversion device 114 fine tunes the optical axis of the rotatable half-wave plate to control a ratio of the polarization components of the incident light that are perpendicular to each other such that the recording powers of the reference light and the signal light are the same. Since the ratio of the polarization components is controlled, the intensities of the reference light and the signal light subsequently divided from a first polarization beam splitter 116 can be controlled. In aspects of the present invention, the recording power of the reference light is controlled to be the same as that of the signal light based on a determination that a difference of the recording powers of the reference light and the signal light is within a designated tolerance. In aspect of the present invention, the recording powers of the reference light and the signal light may be exactly the same or substantially the same.

The first polarization beam splitter 116 can transmit or reflect light depending on its polarization direction. For example, the first polarization beam splitter 116 can transmit s-polarized light and reflect p-polarized light. Accordingly, the first polarization beam splitter 116 can reflect the reference light having p-polarization and transmit the signal light having s-polarization to separate the light paths of the reference light and the signal light during the recording mode.

The first polarization device 118, the reference beam splitter 120, and the reference light detector 124 form a recording power detecting unit of the reference light. The second polarization device 140, the signal beam splitter 142, and the signal light detector 146 form a recording power detecting unit of the signal light.

The first and second polarization devices 118 and 140 change a portion of the polarization component of the incident light into a perpendicularly polarized component thereto. For example, each of the first and second polarization devices 118 and 140 can be a half-wave plate. The optical axis of the half-wave plate can be disposed to slightly deviate from the polarization direction of incident light, for example. Meanwhile, each of the reference beam splitter 120 and the signal beam splitter 142 can be a polarization beam splitter. Accordingly, for example, the reference light having p-polarization obtains a slight s-polarization component while passing through the first polarization device 118. This reference light having the slight s-polarization component is separated by the reference beam splitter 120 and detected by the reference light detector 124. Also, the signal light having s-polarization obtains a slight p-polarization component while passing through the second polarization device 140. This signal light having the slight p-polarization component is separated by the signal beam splitter 142 and detected by the signal light detector 146.

At this point, since the ratio of a changed polarization component that is perpendicular thereto via the first and second polarization devices 118 and 140 can be set during an optical pickup assembling process, light intensities of the reference light and signal light that branch from the first polarization beam splitter 116 can be known through the light intensities of the reference light and the signal light detected by the reference light detector 124 and the signal light detector 146. The above-described recording power detecting unit is provided as an example, and aspects of the present invention are not limited thereto. Half-mirror type beam splitters can be used as the reference beam splitter and the signal beam splitter without the separate first and second polarization devices 118 and 140.

In reference to FIG. 1, the first and second focus control units 132 and 158 are disposed on the light paths of the branching reference light and signal light, respectively. The first and second focus control units 132 and 158 can be active type release lens units. The active type release lens unit includes, for example, a plurality of lenses 132a (158a) and 132b (158b). At least one lens 132b (158b) is movably installed in an optical axis direction and driven by the driving unit. The first focus control unit 132 changes the focus position of the objective lens 138 with respect to the reference light to allow the focus of the reference light to be formed at different positions in the depth direction inside the holographic information storing medium 300. Likewise, the second focus control unit 158 changes the focus position of the objective lens 164 with respect to the signal light to allow the focus of the signal light to be formed at different positions in the depth direction inside the holographic information storing medium 300. When the foci of the reference light and the signal light are formed at different positions along the depth direction of the holographic information storing medium, an information plane on which information is written can be formed in a plurality of layers.

The first and second quarter-wave plates 134 and 160 change linearly polarized light into circularly polarized light and vice versa. The first and second quarter-wave plates 134 and 160 separate light for recording/reproducing operations that is incident onto the holographic information storing medium 300, and light for recording/reproducing operations that is reflected by the holographic information storing medium 300.

The wavelength selective beam splitter 136 couples a servo optical system to a recording/reproducing optical system. The wavelength selective beam splitter 136 serves as a dichroic mirror to function as a simple mirror with respect to a wavelength of the first light source 110 (i.e., light for the recording/reproducing operations), and to simply transmit a wavelength of the second light source 170 (i.e., servo light).

The shutter 148 is a member to block the signal light while an operation of controlling the second focus control unit on a signal light side is performed. The operation of controlling the second focus control unit is required before a recording operation is performed during the recording mode.

The first and second objective lenses 138 and 164 condense the light for the recording/reproducing operations, or the servo light, onto a predetermined region of the holographic information storing medium 300. The first and second objective lenses 138 and 164 can change the foci of the reference light and the signal light that are formed inside the holographic information storing medium 300 in cooperation with the first and second focus control units 132 and 158, and further make a number of apertures of the optical system with respect to the reference light different from a number of apertures of the optical system with respect to the signal light. For example, a sufficient tolerance can be secured at least when the optical system for a signal light side is designed by making relatively large the number of apertures of the optical system with respect to the signal light.

Next, the servo optical system is described. The second light source 170 emits the servo light. For example, the second light source 170 can be a semiconductor laser diode to emit red light. The second light source 170 may emit a linearly polarized light in one direction. For example, the servo light polarization beam splitter 174 can be a polarization beam splitter. The servo light polarization beam splitter 174 separates the servo light that is incident onto the holographic information storing medium 300 and the servo light that is reflected by the holographic information storing medium 300 using a polarization direction. The servo light focus control unit 178 varies the focus position of the servo light inside the holographic information storing medium 300 along the depth direction. The servo light focus control unit 178 can be a relay lens unit including a plurality of lenses 178a and 178b.

A detecting lens 176 allows a light spot of the reflected servo light to be properly formed on the servo light detector 177. For example, the detecting lens 176 can be an astigmatism lens to detect a focus error signal using an astigmatism method. The servo light detector 177 includes a plurality of light detectors to detect servo information and a servo error signal contained on the servo layer of the holographic information storing medium 300. The above-described servo optical system is provided as an example optical system using the servo light having a wavelength different from a wavelength of light for recording/reproducing operations, and the aspects of the present invention are not limited thereto.

Next, the circuit unit 200 according to an aspect of the present invention is described. The circuit unit 200 includes a controller 210, first and second detectors 220 and 230, a position detector 240, and a rotation driving controller 250. The controller 210 controls the light pickup optical system 100, and particularly, controls the light pickup optical system 100 such that the recording powers of the reference light and the signal light are the same. The first and second detectors 220 and 230 convert the intensities of the reference light and the signal light detected by the reference light detector 124 and the signal light detector 146 into radio frequency (RF) signals, respectively, and deliver the RF signals to the controller 210.

The position detector 240 detects a recording position inside the holographic information storing medium 300. For example, the position detector 240 detects the position of the lens 132b inside the first focus control unit 132 to detect the focus position of the reference light formed inside the holographic information storing medium 300 to locate a recording position. The controller 210 performs an operation on the recording powers of the reference light and the signal light, and the intensities of the reference light and the signal light measured by the first and second detectors 220 and 230, with consideration of the recording position detected by the position detector 240.

Next, the operation of the holographic information recording and/or reproducing apparatus according to an aspect of the present invention will be described with reference to FIGS. 1 through 3. The holographic information storing medium 300 used for the holographic information recording and/or reproducing apparatus according to an aspect of the present invention is a two-sided illumination type medium, and includes a holographic recording layer 320, and first and second protection layers 310 and 330 to protect the holographic recording layer 320 on two sides. The holographic recording layer 320 is formed of a photo polymer, which is photo-reactive material on which a micro hologram, i.e., a fine interference pattern, can be recorded. The first and second protection layer 310 and 330 are formed of a transparent material to transmit light for the recording/reproducing operations or the servo light.

To record information in the holographic information storing medium 300, the focusing operations of the first and second objective lenses 138 and 164 should be performed. For this purpose, the second light source 170 is driven to illuminate the servo light onto the holographic information storing medium 300. The servo light focus control unit 178 is controlled so that the focus of the servo light is formed on a servo layer (not shown) inside the holographic information storing medium 300. Next, the first light source 110 is driven to illuminate the reference light onto the holographic information storing medium 300.

At this time, the shutter 148 is closed so that the signal light is not detected. A portion of the reference light illuminated onto the holographic information storing medium 300 is reflected and detected by the first light detector 130. The reference light can be focused by controlling the first focus control unit 132 using a signal of the detected reference light. Also, a portion of the reference light that is illuminated onto the holographic information storing medium 300 passes through the holographic information storing medium 300 and is detected by the second light detector 154. The focus of signal light can be controlled by controlling the second focus control unit 158 using a signal of the detected reference light. Next, the shutter 148 is opened, and the recording powers of the reference light and the signal light are controlled. This aspect considers a recording position inside the holographic information storing medium 300 in controlling the recording powers of the reference light and the signal light.

Information can be recorded on a plurality of planes by controlling the first and second focus control units 132 and 158, and changing the focus positions of the reference light and the signal light. For example, as illustrated in FIG. 3, a recording position can be moved from a zeroth information plane L0 to an n-th information plane Ln along the depth direction of the holographic recording layer 320. However, since the lens positions of the first and second focus control units 132 and 158 change as the recording position changes, effective lights of the reference light and the signal light that are actually used for a recording operation change.

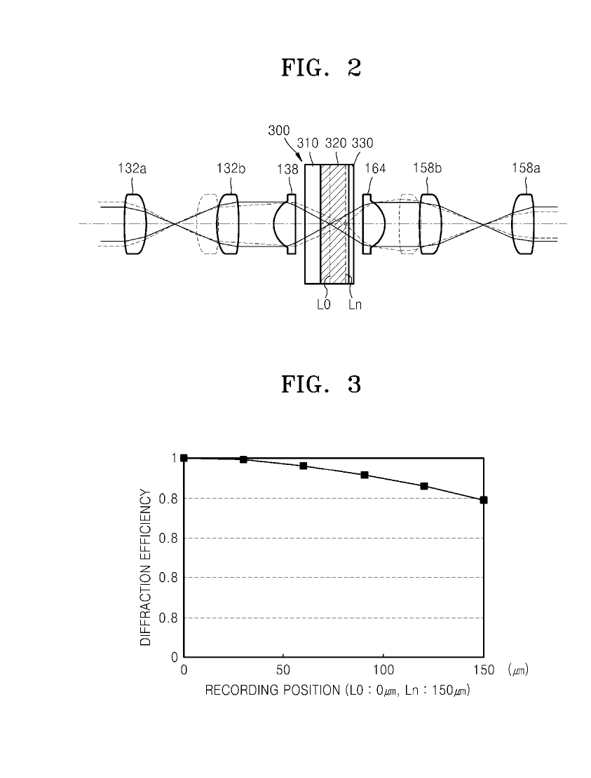

For example, assuming that sizes of the effective lights of the reference light and the signal light are the same during a recording operation on the zeroth information plane L0 (shown as a solid line in FIG. 2), the reference light diverges from the lens 132b of the first focus control unit 132 and condenses onto the n-th information plane Ln, and conversely, the signal light converges at the lens 158b of the second focus control unit 158 and condenses onto the n-th information plane Ln during a recording operation on the n-th information plane Ln. Consequently, the effective size of the reference light during the recording operation on the n-th information plane Ln is greater than that of the reference light during the recording operation on the zeroth information plane L0, and the effective size of the signal light during the recording operation on the n-th information plane Ln is smaller than that of the signal light during the recording operation on the zeroth information plane L0. Accordingly, the size of the effective light of the reference light is different from that of the effective light of the signal light during the recording operation on the n-th information plane Ln. That is, as a recording position changes, RIM intensities of the reference light and the signal light vary, and a difference occurs in the recording powers of the reference light and the signal light for a corresponding information plane. Here, the RIM intensity refers to a light intensity value at an edge of the effective light on the assumption that the intensity of the light at a center of a beam of the light is normalized to 1.

A difference between the recording powers of the reference light and the signal light reduces diffraction efficiency, and thus, a micro hologram by interference between the reference light and the signal light is weakly or barely formed to seriously reduce recording quality. FIG. 3 illustrates diffraction efficiencies of the micro hologram versus recording positions when the numbers of apertures of the first and second objective lenses are set to 0.55, and the distances between the first and second objective lenses 138 and 164, and the lenses 132b and 158b of the first and second focus control units adjacent to the first and second objective lenses 138 and 164, are set to 50 mm. Referring to FIG. 3, diffraction efficiency decreases as recording positions change assuming that the intensities of the reference light and the signal light are fixed and the diffraction efficiency at the zeroth information plane L0 is 1.

To suppress changes in the diffraction efficiency according to the recording positions, aspects of the present invention makes the recording power of the reference light the same as that of the signal light. When the intensities of the reference light and the signal light detected by the first and second detectors 220 and 230, and recording position information detected by the position detector 240, are delivered to the controller 210, the controller 210 judges whether the recording power of the reference light is the same as that of the signal light. To compare the recording powers of the reference light and the signal light in the holographic information storing medium 300, correction needs to be made to the intensities of the reference light and signal light detected by the first and second detectors 220 and 230.

Since the aperture size and the number of apertures of the optical system can change with respect to the reference light and signal light, such changes are considered. Since the number of apertures depending on a recording position does not meaningfully change (or change much) in its size, the number of apertures is assumed to be the same, and the intensities of the reference light and the signal light can be operated with consideration of the aperture sizes of the reference light and the signal light according to a recording position. The aperture size of the optical system is ultimately related to RIM intensity, and the RIM strength can be calculated in advance through a simulation using a diverging angle of the first light source 110 and the aperture size of the optical system. Therefore, whether the recording power of the reference light is the same as that of the signal light can be judged using information regarding the RIM intensity calculated in advance.

In the case where the numbers of apertures of the light pickup optical system with respect to the reference light and the signal light are the same, Equation 1 describing a relationship of the recording powers of the reference light and the signal light can be calculated as follows.

|RIMₛ×Iₛ−RIMᵣ×Iᵣ|<T , [Equation 1]

where Iᵣ is light power of the reference light, Iₛ is light power of the signal light, RIMᵣ is a RIM intensity of the reference light, RIMₛ is a RIM intensity of the signal light, and T is a tolerance in a recording power difference.

For another example, in the case where the numbers of apertures of the light pickup optical system with respect to the reference light and the signal light are different from each other, Equation 2 describing a relationship of the recording powers of the reference light and the signal light can be calculated with consideration of the numbers of apertures as follows.

$$\frac{{RIM}_{s} \times {I}_{s}}{{π ( \frac{λ}{2 {NA}_{s}} )}^{2}} - \frac{{RIM}_{r} \times {I}_{r}}{{π ( \frac{λ}{2 {NA}_{r}} )}^{2}} 〈 T , \qquad [ Equation 2 ]$$

where Iᵣ is light power of the reference light, Iₛ is light power of the signal light, RIMᵣ is a RIM intensity of the reference light, RIMₛ is a RIM intensity of the signal light, λ is the wavelength of the reference light and the signal light, NAᵣ is the number of aperture of an optical system with respect to the reference light, and NAᵣ is the number of aperture of the optical system with respect to the signal light.

When a difference between the recording powers of the reference light and the signal light with consideration of the RIM intensities is smaller than the tolerance T as in Equations 1 and 2, the controller 210 judges the recording powers of the reference light and the signal light are the same and performs a recording operation. When the difference between the recording powers is greater than the tolerance T, the controller 210 judges that the recording powers of the reference light and the signal light are different from each other, and sends a control signal that drives the polarization conversion device 114 to the rotation driving controller 250. The rotation driving controller 250 rotates the rotatable half-wave plate of the polarization conversion device 114 until the difference between the recording powers of the reference light and the signal light is smaller than the tolerance T to equalize the recording powers of the reference light and the signal light.

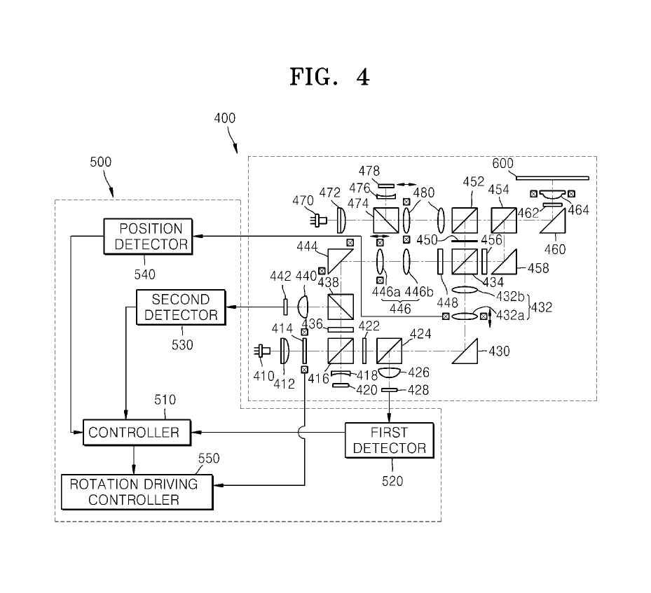

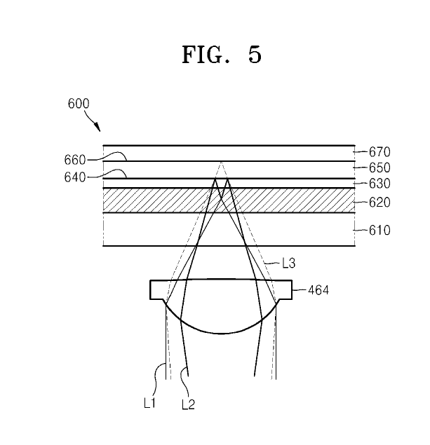

FIG. 4 is a schematic view of the optical construction of a holographic information recording and/or reproducing apparatus according to another aspect of the present invention. FIG. 5 illustrates a holographic information storing medium used for the holographic information recording and/or reproducing apparatus of FIG. 4 and a reference light and a signal light illuminated onto the holographic information storing medium.

Referring to FIG. 4, the holographic information recording and/or reproducing apparatus records/reproduces information to/from a holographic information storing medium 600, and includes a light pickup optical system 400 to illuminate light onto a single side of the holographic information storing medium 600 and to receive the illuminated light, and a circuit unit 500.

Referring to FIG. 5, the holographic information storing medium 600 used for the holographic information recording and/or reproducing apparatus is a reflection type medium that includes a protection layer 610, a holographic recording layer 620, a space layer 630, a reflection layer 640, a buffer layer 650, a servo layer 660, and a substrate 670. Directly focused reference light L1 and signal light L2 reflected by the reflection layer 640 are focused to form a focus in the holographic recording layer 620 to perform a recording operation. Servo light L3 is reflected by the servo layer 650. Particularly, characteristic of the optical arrangement of this aspect of the present invention lies in the reflection layer 660 of the holographic information storing medium 600. The reflection layer 660 can be applied to the case where cholesteric liquid crystal reflection layer formed of cholesteric liquid crystal in a liquid crystal state or a cured liquid crystal film state is used. The cholesteric liquid crystal has a structure where directors of liquid crystal molecules are twisted in a spiral shape to reflect circularly polarized light corresponding to the spiral shape and to transmit circularly polarized light corresponding to an opposite direction to the spiral shape. Accordingly, the cholesteric liquid crystal can separate light into two circularly polarized lights that are perpendicular to each other, and allow the reflected light to maintain an original circular polarization. However, aspects of the present invention is not limited to the holographic information storing medium 600 having the cholesteric liquid crystal reflection layer, but can be applied to cases where a general reflection layer is used by slightly modifying the optical arrangement of this aspect.

The aspect of the present invention of FIG. 4 is the substantially the same as the aspect of the holographic information recording and/or reproducing apparatus described with reference to FIG. 1, with the only difference being application of the reflection type holographic information storing medium 600 illustrated in FIG. 5. Therefore, elements such as the servo optical system excluding the arrangement for illuminating the reference light and the signal light onto the single side of the holographic information storing medium 600 are substantially the same as those of the aspect of FIG. 1. Therefore, descriptions of elements represented by the same names and functions as those of the holographic information recording and/or reproducing apparatus described with reference to FIG. 1 are omitted.

Referring to FIG. 4, a light pickup optical system 400 includes a first light source 410, a first collimating lens 412, a first polarization conversion device 414, a first polarization beam splitter 416, a first polarization device 422, a reference beam splitter 424, a reference light detector 428, a first focus control unit 432, a second polarization beam splitter 434, a second polarization device 436, a signal beam splitter 438, a signal light detector 442, a second focus control unit 446, a third polarization device 448, a shutter 450, a wavelength selective beam splitter 452, a third polarization beam splitter 454, a second polarization conversion device 456, a quarter-wave plate 462, and an objective lens 464. Also, the light pickup optical system 400 can further include a recording/reproducing light detector 420 to detect light for recording/reproducing operations reflected by or passing through a holographic information storing medium 600 during the recording/reproduction operations. Furthermore, the light pickup optical system 400 can further include a servo optical system that includes a second light source 470, a servo polarization beam splitter 474, a servo light focus control unit 480, and a servo light detector 478 in order to read servo information. Reference numerals 412 and 472 refer to collimating lenses to collimate light into parallel light, and reference numerals 418, 426, 440, and 476 refer to lenses to make light detection easer. Also, reference numerals 430, 444, 458, and 460 refer to mirrors that change a light path.

The first light source 410 emits light linearly polarized in one direction for recording/reproducing operations. The light for the recording/reproducing operations emitted from the first light source 410 is modulated and emitted during a recording mode, and is emitted without modulation during a reproducing mode. The first polarization conversion device 414, for example, includes a rotatable half-wave plate that can control a ratio of polarization components of incident light that are perpendicular to each other, and a driving unit driving the rotatable half-wave plate to control the ratio of the polarization components of the incident light that are perpendicular to each other in response to a control from the circuit unit 500. The intensities of a reference light and a signal light branching from the first polarization beam splitter 416 can be controlled by controlling the polarization components.

The first polarization device 422, the reference beam splifter 424, and the reference light detector 428 form a recording power detecting unit of the reference light. The second polarization device 436, the signal beam splitter 438, and the signal light detector 442 form a recording power detecting unit of the signal light. Since the recording power detecting unit according to this aspect is the same as that described with reference to FIG. 1, a detailed description thereof is omitted.

The first and second focus control units 432 and 446, for example, can be active type release lens units that include a plurality of lenses 432a (446a) and 432b (446b). The first and second focus control units 432 and 446 are disposed on the light paths of the branching reference light and the signal light, respectively, to allow the foci of the reference light and the signal light to be formed at different positions, respectively, in the depth direction inside the holographic information storing medium 600.

The third polarization device 448, the second polarization beam splitter 434, the shutter 450, the wavelength selective beam splitter 452, the third polarization beam splitter 454, and the second polarization conversion device 456 split the light paths of the reference light and the signal light reflected by the holographic information storing medium 600 using polarization to enhance use or utilization efficiencies of the reference light and the signal light. The third polarization device 448 can be a half-wave plate. The third polarization device 448 can change s-polarized light into p-polarized light and vice versa. The second polarization conversion device 456 can be an active type half-wave plate. The second polarization conversion device 456 serves as a half-wave plate during a recording mode, and does not serve as a half-wave plate during a reproducing mode.

Meanwhile, it is possible to allow a portion of the incident light to maintain an original polarization state by allowing the optical axis of the half-wave plate to slightly deviate from 45 degrees with respect to the polarization direction of the incident light during a recording mode. In this case, a portion of the reflected signal light is not polarized while passing through the second polarization conversion device 456, is reflected by the second polarization beam splitter 434, reverses the light path of the reference light toward the first polarization beam splitter 416, and can be detected by the recording/reproducing light detector 420. Like the shutter 148 of FIG. 1, the shutter 450 is closed while the foci of the reference light and the signal light are controlled using the reference light before a recording operation is performed, so that only reflected/transmitted light of the reference light can be detected through the recording/reproducing light detector.

The quarter-wave plate 462 changes linearly polarized light into circularly polarized light and vice versa. As described above, since the holographic information storing medium 600 maintains the polarization direction of circular polarization and reflects the light, the polarization directions of the reference light and the signal light incident from the third polarization beam splitter 454 to the quarter-wave plate 442 are the same as those of the reference light and the signal light reflected from the quarter-wave plate 462 to the third polarization beam splitter 454.

Next, the operation of the holographic information recording and/or reproducing apparatus according to an aspect of the present invention is described. During a recording mode, a reference light and a signal light, each having polarization components that are perpendicular to each other, branch from the first polarization beam splitter 416, pass through different paths, respectively, and are illuminated onto the holographic information storing medium 600. It is assumed that the reference light and the signal light branching from the first polarization beam splitter 416 are p-polarized and s-polarized, respectively, for convenience of description. The reference beam splitter 424 and the second and third polarization beam splitters 434 and 454 can transmit p-polarized light, and reflect s-polarized light whereas the signal beam splitter 438 can transmit s-polarized light and reflect p-polarized light. In this case, the p-polarized reference light passes through the reference beam splitter 424 and the second and third polarization beam splitters 434 and 454 to propagate toward the objective lens 464. On the other hand, the s-polarized signal light passes through the signal beam splitter 438, is changed into p-polarized light by the third polarization device 448, passes through the second polarization beam splitter 434, is changed into s-polarized light by the second polarization conversion device 456, and then is reflected by the third polarization beam splitter 454 to the objective lens 464. At this time, the p-polarized reference light has a slight s-polarization component while passing through the first polarization device 422, and the slight s-polarization component is reflected by the reference beam splitter 424 and is detected by the reference light detector 428. Also, the s-polarized signal light while passing through the second polarization device 436 has a slight p-polarization component, and the slight p-polarization component is reflected by the signal beam splitter 438 and is detected by the signal light detector 442. Light intensities of the reference light detected by the reference light detector 428 and the signal light detected by the signal light detector 442 are converted into signals and the signals are delivered through first and second detectors 530 to a controller 510. The controller 510 calculates a recording power difference between the reference light and the signal light. The controller 510 controls a rotation driving controller 550 to drive the first polarization conversion device 414 so that the calculated recording power difference is within a designated tolerance.

Since the shutter 450 is closed while the recording powers of the reference light and the signal light are controlled in this aspect, the reference light is blocked but the signal light reaches the holographic information storing medium 600. Since signal light reflected by the holographic information storing medium 600 maintains s-polarization, the reflected signal light is reflected by the third polarization beam splitter 454, passes through the second polarization conversion device 456, and is incident to the second polarization beam splitter 434. At this point, the second polarization conversion device 456 serves as a half-wave plate because the operation is currently performed during a recording operation. Since the optical axis of the second polarization conversion device 456 slightly deviates from 45 degrees with respect to the polarization direction of incident light, a portion of the reflected signal light maintains an original s-polarization, so it is reflected by the second polarization beam splitter 434, reverses the light path of the reference light to the first polarization beam splitter 416, and is detected by the recording/reproducing light detector 420. The focus positions of the reference light and the signal light can be controlled by detecting the signal light reflected by the recording/reproducing light detector 420, and controlling the first and second focus control units 432 and 446 using a signal of the detected signal light. Next, the shutter 450 is opened and a recording operation is performed on the holographic information storing medium 600.

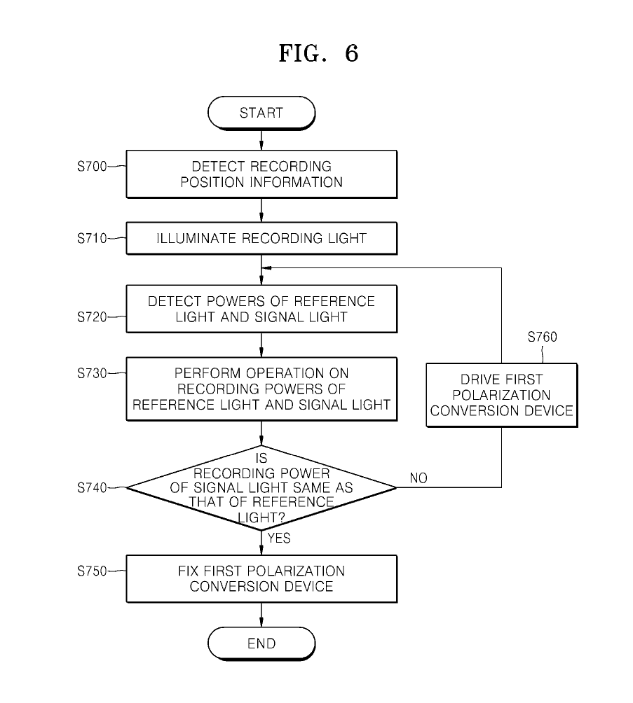

Next, a method of controlling recording powers of a reference light and a signal light according to an aspect of the present invention will now be explained with reference to FIG. 6 in brief.

Once a recording position inside a holographic information storing medium is determined, a focus control unit for controlling focus positions of a reference light and a signal light is driven. In operation S700, recording position information is detected by the driven focus control unit. In operation S710, a light source is driven to illuminate a recording light. The recording light is allowed to have polarization components that are perpendicular to each other using a polarization conversion device, and is divided into a signal light and a reference light by a polarization beam splitter. In operation S720, light intensities of the signal light and the reference light are detected. In operation S730, recording powers of the signal light and the reference light illuminated into the holographic information storing medium are obtained using the detected light intensities of the signal light and the reference light. In operation S740, it is determined whether the obtained recording powers of the signal light and the reference light are the same within a designated tolerance. If it is determined in operation S740 that the obtained recording powers of the signal light and the reference light are the same within the designated tolerance, the method proceeds to operation S750. In operation S750, the recording powers of the signal light and the reference light are maintained by fixing an optical axis of the polarization conversion device. If it is determined in operation S740 that the obtained recording powers are not the same within the designated tolerance, the method proceeds to operation S760. In operation S760, the polarization conversion device is driven to change a ratio of the polarization components that are perpendicular to each other. Operations S720 through S740 are repeated. Accordingly, the method of FIG. 6 can equalize the recording powers of the signal light and the reference light within the designated tolerance.

The holographic information recording and/or reproducing apparatus according to aspects of the present invention can improve rotation efficiency during a recording operation, prevents or reduces deterioration of reproduced signals, and improves a signal-to-noise ratio (SNR) during a reproduction operation by equalizing the recording strengths of the signal light and the reference light.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A holographic information recording and/or reproducing apparatus comprising:
a light pickup optical system to illuminate a reference light and a signal light onto a holographic information storing medium; and
a recording power control unit to control the light pickup optical system such that recording power of the reference light is the same as that of signal light.

2. The apparatus of claim 1, wherein the light pickup optical system comprises:
a light source unit to emit the reference light and the signal light;
a recording power detecting unit to detect light powers of the reference light and the signal light;
a light path guide unit to guide the reference light and the signal light emitted from the light source unit to different light paths, respectively; and
an objective lens optical system to illuminate the reference light and the signal light guided by the light path guide unit onto a holographic information storing medium.

3. The apparatus of claim 2, wherein the light source unit comprises:
a light source; and
a light dividing unit to divide an incident light from the light source unit into the reference light and the signal light, the light dividing unit controlling a ratio of the reference light to the signal light.

4. The apparatus of claim 3, wherein the light dividing unit comprises:
a polarization conversion device to control a ratio of polarization components of the incident light that are perpendicular to each other; and
a polarization beam splitter to divide the incident light that has passed through the polarization conversion device according to the polarization components of the incident light.

5. The apparatus of claim 4, wherein the polarization conversion device comprises:
a rotatable half-wave plate to rotate around an optical axis to change an angle between the optical axis and a polarization direction of the incident light; and
a driving unit to drive the rotatable half-wave plate, the driving unit being controlled by the recording power control unit.

6. The apparatus of claim 5, wherein the polarization conversion device polarization-converts the incident light such that the incident light has linear polarization components perpendicular to each other, and polarization-converts the incident light such that the incident light has only a polarization component of the reference light during a reproducing mode.

7. The apparatus of claim 2, wherein the light pickup optical system further comprises a focus control unit to control positions of foci of the reference light and the signal light formed in the holographic information storing medium in a depth direction to form a plurality of information planes formed of interference patterns between the reference light and the signal light.

8. The apparatus of claim 7, wherein the focus control unit comprises one of a relay lens unit and a beam expander provided respectively on light paths of the reference light and the signal light guided by the light path guide unit to paths different from each other.

9. The apparatus of claim 8, wherein the recording power control unit comprises a position detector detecting a recording position from the focus control unit.

10. The apparatus of claim 2, wherein the recording power detecting unit comprises:
a first beam splitter and a second beam splitter located respectively on light paths of the reference light and the signal light guided by the light path guide unit to paths different from each other, respectively; and
a reference light detector and a signal light detector to detect the reference light and the signal light branching from the first and second beam splitters, respectively.

11. The apparatus of claim 2, wherein the recording power detecting unit comprises a first polarization device and a second polarization device disposed between a polarization beam splitter and a first beam splitter, and between the polarization beam splitter and a second beam splitter to reflect a portion of a polarization component of an incident light into a polarization component that is perpendicular to the portion of the polarization component, the first and second beam splitters being polarization beam splitters.

12. The apparatus of claim 11, wherein each of the first and second polarization devices comprises a half-wave plate.

13. The apparatus of claim 2, wherein the light path guide unit guides the reference light and the signal light emitted from the light source unit such that they are illuminated to face each other on both sides of the holographic information storing medium.

14. The apparatus of claim 2, wherein the light path guide unit guides the reference light and the signal light emitted from the light source unit such that they are illuminated on one side of the holographic information storing medium.

15. The apparatus of claim 1, wherein the recording power control unit performs an operation on recording powers of the reference light and the signal light to compare the recording powers using light powers of the reference light and the signal light detected by the light pickup optical system.

16. The apparatus of claim 15, wherein the recording power control unit performs an operation on recording powers of the reference light and the signal light to compare the recording powers with consideration of change in a number of apertures, change in aperture sizes of the reference light and the signal light depending on a recording position, and light powers of the reference light and the signal light detected by the light pickup optical system.

17. The apparatus of claim 15, wherein the recording power control unit controls the light pickup optical system such that following Equation is satisfied when the number of apertures for the reference light and the number of apertures for the signal light of the light pickup optical system are the same:

|RIMₛ×Iₛ−RIMᵣ×Iᵣ|<T,
where Iᵣ is light power of the reference light, Iₛ is light power of the signal light, RIMᵣ is RIM intensity of the reference light, RIMₛ is RIM intensity of the signal light, and T is tolerance of difference in the recording powers thereof.

18. The apparatus of claim 15, wherein the recording power control unit controls the light pickup optical system such that following Equation is satisfied when the number of apertures for the reference light and the number of apertures for the signal light of the light pickup optical system are different from each other:
$$\frac{{RIM}_{s} \times {I}_{s}}{{π ( \frac{λ}{2 {NA}_{s}} )}^{2}} - \frac{{RIM}_{r} \times {I}_{r}}{{π ( \frac{λ}{2 {NA}_{r}} )}^{2}} 〈 T ,$$
where Iᵣ is light power of the reference light, Iₛ is light power of the signal light, RIMᵣ is RIM intensity of the reference light, RIMₛ is RIM intensity of the signal light, λ is the wavelength of the reference light and the signal light, NAᵣ is the number of aperture of the optical system with respect to the reference light, and NAₛ is the number of aperture of the optical system with respect to the signal light.

19. The apparatus of claim 1, wherein the recording power of the reference light is controlled to be the same as that of signal light based on a determination that a difference of the recording powers of the reference light and the signal light is within a designated tolerance.

20. The apparatus of claim 5, wherein the optical axis of the rotatable half-wave plate is set to be the same as the polarization direction of the incident light during a reproducing mode.

21. A holographic information recording and/or reproducing apparatus comprising:
a light pickup optical system to provide a reference light and a signal light to a holographic information storing medium, the reference light and the signal light generating interference patterns representing data for recording in the holographic information storing medium;
a recording power detecting unit to detect recording powers of the reference light and the signal light that vary based on change in locations of foci formed by the reference light and the signal light in a depth direction of the holographic information storing medium; and
a recording power control unit to control the light pickup optical system to adjust the respective recording powers of the reference light and the signal light based on a determination that a difference of the recording powers of the reference light and the signal light is within a designated tolerance so the respective recording powers are considered to be the same.

22. The apparatus of claim 21, wherein adjusting of the respective recording powers of the reference light to be the same reduces deterioration of reproduced signals, and improves a signal-to-noise ratio (SNR) during a reproduction operation by equalizing the recording strengths of the signal light and the reference light.

23. A method of recording data on a holographic information storing medium using a holographic information recording and/or reproducing apparatus, the method comprising:
providing a reference light and a signal light to the holographic information storing medium, the reference light and the signal light generating interference patterns representing data for recording in the holographic information storing medium;
detecting recording powers of the reference light and the signal light that vary based on change in locations of foci formed by the reference light and the signal light in a depth direction of the holographic information storing medium; and
adjusting the respective recording powers of the reference light and the signal light based on a determination that a difference of the recording powers of the reference light and the signal light is within a designated tolerance so the respective recording powers are considered to be the same.
